(19) United States
(12) Patent Application Publication
(10) Pub. No.: US 2026/0287222 A1
(43) Pub. Date: Sep. 24, 2026

(54) INDIRECT THERMAL MANAGEMENT SYSTEM FOR NEW ENERGY VEHICLES

(71) Applicant: Zaidao Yang, Windsor (CA)

(72) Inventor: Zaidao Yang, Windsor (CA)

(21) Appl. No.: 19/183,779

(22) Filed: Apr. 19, 2025

Related U.S. Application Data
(60) Provisional application No. 63/773,437, filed on Mar. 18, 2025.

(51) Int. Cl. F25B 29/00; B60H 1/00; B60K 11/04; B60L 58/26; B60L 58/33; F25B 9/00; F25B 43/00

(52) U.S. Cl. CPC F25B 29/003; B60H 1/00278; B60L 58/26; B60L 58/33; F25B 9/008; F25B 43/006; B60K 11/04; F25B 2400/23

(57) ABSTRACT

The present invention relates to an indirect thermal management system for new energy vehicles (NEVs). The system employs an integrated refrigerant loop and a coolant loop that enables heap pump function. The heat pump function of this system is enabled through the control of coolant loop valves instead of refrigerant valves. The invention reduces refrigerant usage and leakage risks, improve reliability, enhances compatibility with high pressure refrigerants such as R744 (CO₂), and ensures scalable integration across various vehicle platforms and industrial applications. The refrigerant loop comprises a compressor, two heat exchangers and an expansion valve to regulate thermal energy transfer. The coolant loop circulates heat between the refrigerant system and vehicle components such as the battery pack, motors, cabin, refrigerator, and external radiator.

### RELATED U.S. APPLICATION

This application claims priority to U.S. provisional Application No. 63/773,437, titled ‘INDIRECT THERMAL MANAGEMENT SYSTEM FOR NEW ENERGY VEHICLES’, and filed on Mar. 18, 2025.

### BACKGROUND OF THE INVENTION

The present invention relates to a thermal management system for new energy vehicles (NEVs), including battery electric vehicles (BEVs), fuel cell electric vehicles (FCEV) and hybrid electric vehicles (HEVs). Specifically, it discloses an indirect thermal management system utilizing an integrated refrigerant loop and independent coolant loops to enhance compatibility with high-pressure refrigerants such as R744 (CO₂), optimize thermal efficiency, improve system reliability, and reduce refrigerant usage, leakage risks and environmental impact.

Conventional NEV thermal management systems directly circulate refrigerant to cooling and heating loads, such as external radiator as condenser, evaporator for vehicle cabins and heat exchanger for battery pack. To facilitate heat pump function, these systems typically require multiple expansion valves, shut off valves and complex refrigerant pathways, which increases system cost, high refrigerant consumption, high refrigerant leakage risks, excessive pressure losses, compromised system reliability and high costs of manufacturing, maintenance and warranty. Existing direct and indirect heat pump systems in the marketplace typically suffer from refrigerant loop complexity, coolant loop loads scalability limitations, suboptimal thermal performance at low-temperature conditions, and demand intricate control algorithms for operation. Therefore, there exists a need for a simplified, compact and environmentally friendly thermal management system that decouples refrigerant circulation from direct thermal loads while improving low temperature performance and reliability.

### BRIEF SUMMARY OF THE INVENTION

The disclosed indirect thermal management system provides with cooling and heating modes. Switching between cooling and heating is controlled by low pressure liquid coolant loops instead of high pressure refrigerant loop.

It consists of two subsystems: (1) a refrigerant loop and (2) a coolant loop system. The refrigerant loop is confined within a compact system containing a compressor, condenser as hot source, an expansion valve, evaporator as cold source, while the coolant loop system circulates thermal energy to different vehicle components including external radiator, cabin, battery, power electronics, electric motor(s), refrigerator etc.

The refrigerant circuit is a compact closed-loop system, transferring heat between the first and second heat exchangers. It comprises: A compressor for pressurizing refrigerant, with heating feature or heat generation mode; A first heat exchanger (condenser) for refrigerant heat rejection and hot source for coolant loops; A refrigerant expansion valve for refrigerant pressure regulation; A second heat exchanger (evaporator) for refrigerant heat absorption and cold source for coolant loops; Pressure and Temperature sensors for monitoring system performance; A dryer filter; A gas-liquid separator, with PTC heating option to improve heat pump performance at lower temperatures.

The coolant loop integrates: A heating-side heat exchanger (the first heat exchanger as condenser in the refrigerant loop); A cooling-side heat exchanger (the second heat exchanger as evaporator in the refrigerant loop); Independent coolant circulation modules for different vehicle loads, including but not limited to: Cabin (for Heating, Cooling, and Dehumidification with a PTC Heater), Battery (Heating, Cooling), Thermal storage container (Refrigerator/Freezer/Warming Box), Motors, power electronics, and charging module (Cooling), External radiator (for excessive heat dissipation) and Fuel Cell (Cooling) etc..

Each load module of coolant loop system operates independently via a dedicated twin-valve and pump module, allowing flexible thermal control and dynamic response to operating conditions. The twin-valve comprises three operational modes, each corresponding to predefined valve positions: a Heating Mode, wherein coolant flow is selectively directed to the heating-side heat exchanger; a Cooling Mode, wherein coolant flow is selectively directed to the cooling-side heat exchanger; and a Closed Mode, wherein coolant flow is entirely obstructed to prevent circulation through either heat exchanger.

### Key Advantages of the System

Redistributed Complexity Architecture: This system integrates heat pump functionality into coolant loop valve control, thereby simplifying refrigerant loop architecture. The compact refrigerant loop design reduces component count and flow path length by reducing quantities of heat exchangers, refrigerant expansion valves and high-pressure refrigerant pathways. Reduced refrigerant usage and simplified refrigerant loop structure minimize leakage risks and environmental impact.
Enhanced Reliability Through Simplification: Facilitating heat pump operations within the coolant loop system reduces potential refrigerant leak points compared to conventional systems. Enhanced long-term reliability is achieved through minimized thermal cycling of high-pressure components.
Streamlined Control Architecture: The coolant loop system enables efficient thermal management via simplified control logics and improved integration between twin-valve matrices and pump systems.
Superior Energy Efficiency: Optimized compressor operation, reduced refrigerant loop pressure losses, dynamically balancing heat transfer across coolant loop modules improve the coefficient of performance (COP) of the system.
Scalable Modularity: Parallel coolant branches allow flexible thermal load module deletion or expansion to accommodate diverse applications without compromising system integrity.
Low-Temperature Heat Pump Operation: Operational strategies that enable effective heating at lower temperatures are achieved through one or more of below: a). A gas-liquid separator with embedded heating elements accelerates heat pump startup; b). A PTC heater positioned at the compressor suction inlet; c). A compressor with reduced-efficiency operational modes generate supplemental heat; Or d). Improve refrigerant loop sealings and utilize high-pressure refrigerants (e.g., R744) for effective low-temperature operation.

### BRIEF DESCRIPTION OF THE DRAWINGS

FIG. 1 illustrates a schematic diagram of the indirect thermal management system.

FIG. 2 illustrates a minimal embodiment with heat pump function.

### DETAILED DESCRIPTION OF THE INVENTION

The indirect thermal management system employs coolant loop-based control logic to enable seamless mode transitions between cooling and heat pump functions, dynamically optimizing energy transfer efficiency across variable climatic conditions. The system is controlled by a thermal management module based on ambient conditions, thermal loads, user inputs, and operational requirements, which dynamically regulates compressor speed, refrigerant expansion valve position for refrigerant pressure regulation, coolant twin-valve matrix positions and openings for heating and cooling load-specific adjustments, pump speeds to optimize coolant circulation, sensors to monitor pressure, temperature, coolant flow rates for real-time control and diagnostics, as well as fan(s) speed for external radiator, motor speed of cabin blower etc.. The operation modes include but not limited to:
Cooling Mode: The compressor circulates refrigerant through the first heat exchanger (condenser), where heat is rejected to the coolant loop; The heated coolant circulates to the external radiator (ambient heat exchanger), dissipating heat to the environment; Simultaneously, the second heat exchanger (evaporator) absorbs heat from the coolant loop connected to the vehicle loads (cabin, battery, motor, refrigerator etc.); The coolant pumps circulate the cooled coolant through different load modules, ensuring optimal temperature regulation for each component; Besides, the cabin cooling integrates with a PTC heater to enable dehumidification, followed by targeted reheating of the airflow prior to its recirculation within the cabin.
Heat Pump (Heating) Mode: The second heat exchanger (evaporator) extracts heat from the ambient heat exchanger (external radiator) indirectly through coolant, extracts heat through coolant from motor and battery if waste heat is available, transferring it to the refrigerant loop; The compressor pressurizes the refrigerant, increasing its thermal energy; The first heat exchanger (condenser) transfers heat to the coolant loop, distributing warmth to the loads such as cabin, thermal box, and battery if needed; Dynamic control of the valves matrix and pumps matrix ensures optimal heat distribution across all subsystems.

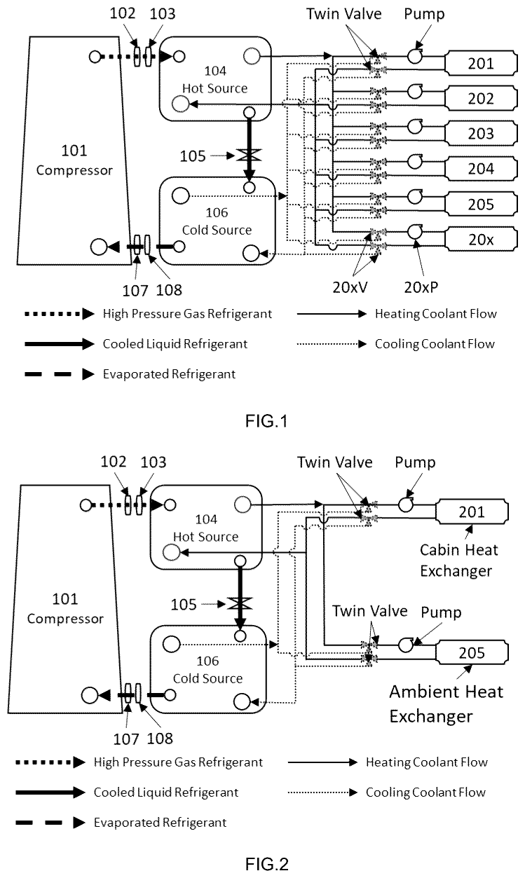

As an example of illustrating an embodiment of this invention and not for limiting the application of the invention, FIG. 1 depicts a schematic diagram of an indirect thermal management system in accordance with the present invention. It consists of a compact refrigerant loop and a coolant loop system with multiple thermal load modules. The refrigerant loop is confined within a compact system containing a Compressor (101), High pressure side Pressure & Temperature Sensors (102), High pressure side service port (103), Condenser as hot source (104), an Expansion Valve (105), Evaporator as cold source (106), pipes and Low pressure side Pressure & Temperature Sensors (107), Drier, Filter, Gas-Liquid Separator (108), while the coolant loop circulates thermal energy to different vehicle components including Cabin Heat Exchanger (201), Battery (202), Thermal Container such as Refrigerator or Warming Box (203), Power Electronics & Electric Motor (204), Twin-Valves and pumps, as well as Ambient Heat Exchanger (205). For the additional reserved thermal load module (20x), which is to demonstrate the scalability of this invention, there are dedicated valve (20xV) and pump (20xP). The coolant loop may incorporate additional valves and bidirectional pumps to facilitate ‘passive’ (without activation of compressor) cabin heating via motor waste heat recovery, and passive motor cooling through coolant channels connecting the motor and ambient heat exchanger.

FIG. 2 illustrates a second example of minimal embodiment of the present disclosure configured to provide cooling and heating to the Cabin with heat pump function facilitated by the control of the valves and pumps in the coolant loop.

In summary, this invention provides an indirect thermal management system with a compact refrigerant loop and coolant loop based control for heat pump that reduces refrigerant loop complexity, reduces refrigerant usage and leakage risks, improves compatibility with high-pressure refrigerants such as R744 (CO₂), and enhances system reliability and scalability for various applications. By decoupling the refrigerant loop from direct heating and cooling loads, the system achieves better reliability and environmental sustainability compared to traditional direct refrigerant circulation methods and other indirect thermal management architectures on the market. Potential applications are Battery Electric Vehicles (BEVs), Plug-In Hybrid Electric Vehicles (PHEVs), Hybrid Electric Vehicles (HEVs), Fuel Cell Electric Vehicles (FCEV) requiring thermal managements for cabin, electric motor(s), fuel cell and storage battery. Furthermore, the inventive concepts disclosed herein may find utility in various other thermal management applications, including but not limited to residential and commercial heat pump systems, industrial heat recovery devices, large-scale heating systems, and scenarios where the benefits of extended coolant loop architectures are desired.

1. An indirect thermal management system, comprising:
a refrigerant loop system including a compressor, a first heat exchanger, a second heat exchanger, an expansion valve, and accessories such as a dryer, a filter, a gas-liquid separator, service ports, and pressure and temperature sensors;
a coolant loop system thermally coupled to the refrigerant loop via the first and second heat exchangers.

2. The system of claim 1, wherein the coolant loop includes independent parallel circulation modules with dedicated valves and pumps for dynamic thermal load management of vehicle components, including but not limited to cabin, battery, motor(s) and power electronics, external radiator, thermal container.

3. The system of claim 1, wherein the heat pump functionality is integrated into coolant loop valve and pump actuation mechanisms, thereby offsetting heat pump system complexity from refrigerant loop to coolant loop.

4. The system of claim 1, wherein the structure of the refrigerant loop is simplified with less heat exchangers and less potential leak points, reduced refrigerant volume and optimized for high-pressure refrigerant compatibility.

5. The system of claim 1, wherein the first and second heat exchangers function as thermal buffers to stabilize refrigerant operation and reduce compressor cycling frequency.

6. The system of claim 1, is applicable to electric, hybrid, and fuel cell vehicles, as well as stationary industrial and residential heat pump systems.

7. The system of claim 1, wherein the heat pump initiates operation from lower temperatures through one or more of:
a gas-liquid separator with a heating function;
a compressor integrated with a heating feature, such as a PTC heater in the suction inlet area;
a compressor operating in a reduced-efficiency mode to generate additional heat;
Utilizing refrigerant of R744 (CO₂), enabling effective operation at lower temperatures.

8. The system of claim 1, wherein the coolant pumps function independently with integration options, including:
a pump exclusively managing coolant flow to the heating-side heat exchanger;
another pump exclusively managing coolant flow to the cooling-side heat exchanger.
